(19) United States
(12) Patent Application Publication
(10) Pub. No.: US 2026/0187077 A1
(43) Pub. Date: Jul. 2, 2026

(54) SYSTEM AND METHOD FOR HOMOGENEOUS RELIABILITY GROUPING

(71) Applicant: THE BOEING COMPANY, Arlington, VA (US)

(72) Inventors: Mahesh Purushothaman, Bengaluru (IN); William Henry Schasteen, JR., Gilbert, AZ (US); Matthew Alan McDonald, Spokane, WA (US); Deepak Kumar, Bengaluru (IN); Anket Hirachand Marathe, Bengaluru (IN); Jason Andrew Koehn, Buckley, WA (US); Prajna Gopalakrishna, Bengaluru (IN)

(21) Appl. No.: 19/006,420

(22) Filed: Dec. 31, 2024

(51) Int. Cl. G06F 16/2455; G06F 16/28

(52) U.S. Cl. CPC G06F 16/24556; G06F 16/285

(57) ABSTRACT

A method includes comparing a first field of a first data record to a first field of a second data record to determine a first similarity metric based on a number of single character changes used to convert a value of the first field of the first data record to a value of the first field of the second data record and comparing a second field of the first data record to a second field of the second data record to determine a second similarity metric based on whether the second field of the first data record is identical to a value of the second field of the second data record. The method includes determining an aggregate similarity metric based on at least the first similarity metric and the second similarity metric and assigning the second data record to a calibration reliability group based on the aggregate similarity metric.

### FIELD OF THE DISCLOSURE

The present disclosure is generally related to generating homogeneous reliability groups.

### BACKGROUND

In various industries, devices must be managed to ensure consistent accuracy and reliability of measurements. A critical aspect of device management is the creation of homogenous reliability groups, where devices with similar reliability characteristics are clustered together for unified management. Traditional approaches to reliability grouping rely on manual processes and subjective judgments, leading to significant operational challenges within measurement information systems.

The manual creation of reliability groups has resulted in widespread non-homogeneity, where multiple groups of the same type frequently exist due to different calibration labs and personnel independently creating groups. This fragmentation leads to situations where similar devices are assigned to different groups, resulting in inconsistent management approaches. Furthermore, many reliability groups contain devices from unrelated instrument types, compromising the effectiveness of subsequent reliability analyses and making it difficult to maintain consistency across large device inventories, with some organizations needing to manage tens of thousands of distinct groups.

Current solutions attempt to address these challenges through various manual methods, including grouping by instrument type, manufacturer, model, or specifications. However, these approaches lack the sophistication needed to account for the complex interrelationships between different device characteristics. The technical problems are further compounded by data quality issues, such as inconsistent naming conventions and varying formats for device information (e.g., “FEELER GAGE,” “FEELER GAUGE,” “GAGE, FEELER”), making it difficult to identify and group similar devices accurately.

As device inventories continue to grow in both size and complexity, there is an increasing need for sophisticated, automated approaches to create and maintain homogenous reliability groups. Such approaches should be capable of processing large volumes of device data, handling variations in data format and nomenclature, and consistently applying complex grouping criteria across entire device inventories.

### SUMMARY

According to one implementation of the present disclosure, a method includes obtaining data including a plurality of records, each record associated with a particular calibrated device. The method also includes comparing a first field of a first data record to a first field of a second data record to determine a first similarity metric based on a number of single character changes used to convert a value of the first field of the first data record to a value of the first field of the second data record. The method also includes comparing a second field of the first data record to a second field of the second data record to determine a second similarity metric based on whether the second field of the first data record is identical to a value of the second field of the second data record. The method also includes determining an aggregate similarity metric based on at least the first similarity metric and the second similarity metric. The method also includes assigning the second data record to a calibration reliability group based on the aggregate similarity metric.

According to another implementation of the present disclosure, a non-transitory computer-readable medium stores instructions that, when executed by one or more processors, cause the one or more processors to obtain data including a plurality of records, each record associated with a particular calibrated device. The instructions further cause the one or more processors to compare a first field of a first data record to a first field of a second data record to determine a first similarity metric based on a number of single character changes used to convert a value of the first field of the first data record to a value of the first field of the second data record. The instructions further cause the one or more processors to compare a second field of the first data record to a second field of the second data record to determine a second similarity metric based on whether the second field of the first data record is identical to a value of the second field of the second data record. The instructions further cause the one or more processors to determine an aggregate similarity metric based on at least the first similarity metric and the second similarity metric. The instructions further cause the one or more processors to assign the second data record to a calibration reliability group based on the aggregate similarity metric.

According to another implementation of the present disclosure, a device includes one or more processors coupled to a memory configured to obtain data including a plurality of records, each record associated with a particular calibrated device. The one or more processors are configured to compare a first field of a first data record to a first field of a second data record to determine a first similarity metric based on a number of single character changes used to convert a value of the first field of the first data record to a value of the first field of the second data record. The one or more processors are configured to compare a second field of the first data record to a second field of the second data record to determine a second similarity metric based on whether the second field of the first data record is identical to a value of the second field of the second data record. The one or more processors are configured to determine an aggregate similarity metric based on at least the first similarity metric and the second similarity metric. The one or more processors are configured to assign the second data record to a calibration reliability group based on the aggregate similarity metric.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system for generating homogenous reliability groups.

FIG. 2 is a flow diagram illustrating operations performed by the device, as in FIG. 1, to generate group data.

FIG. 3 is a flow chart of a method of generating homogenous reliability groups.

FIG. 4 is a diagram of electronic components of a system for generating homogenous reliability groups.

### DETAILED DESCRIPTION

Aspects disclosed herein present systems, apparatus, and methods for automatically grouping similar devices into homogeneous reliability groups. This grouping system helps organizations better manage their calibration devices by ensuring that devices with similar characteristics are managed together, rather than having similar devices spread across different groups or unlike devices grouped together.

The system works by comparing different pieces of information about each device to determine how similar devices are to each other. For example, it looks at the device name (like “torque wrench” or “feeler gauge”), the manufacturer, the model number, and other identifying information. For text information like device names, the system counts how many letter changes it takes to convert one name into another to measure similarity. For other information like model numbers, the system checks whether they match exactly. The system then combines these different similarity measurements, giving more importance to some types of information than others based on how reliable that information is for grouping purposes.

To handle large numbers of devices efficiently, the system uses a specialized sorting and comparison process. First, it sorts all the devices by their names to bring similar devices close together. Then, it compares each device to nearby devices in the sorted list to determine if they should be in the same group. This approach is much faster than comparing every device to every other device, which would take too long with large inventories. The system can also adjust how strict it is about grouping devices together based on how similar the devices need to be for a particular organization's needs.

When making these comparisons, the system accounts for common data entry variations. For example, it can recognize that “FEELER GAGE” and “FEELER GAUGE” refer to the same type of device, even though they are spelled differently. This helps ensure consistent grouping even when device information has been entered inconsistently into the system.

By using the techniques and systems described herein, organizations can achieve several practical benefits. The automated grouping process can handle thousands of devices in minutes rather than the weeks or months it might take to group them manually. The groups created are more consistent because the system always uses the same rules to decide which devices should be grouped together, unlike manual grouping where different people might make different decisions. The system also reduces errors that commonly occur in manual grouping, such as putting similar devices in different groups or mixing unlike devices in the same group. This more accurate grouping helps organizations better maintain their measurement and test equipment, ultimately leading to more reliable measurements and more efficient operations.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

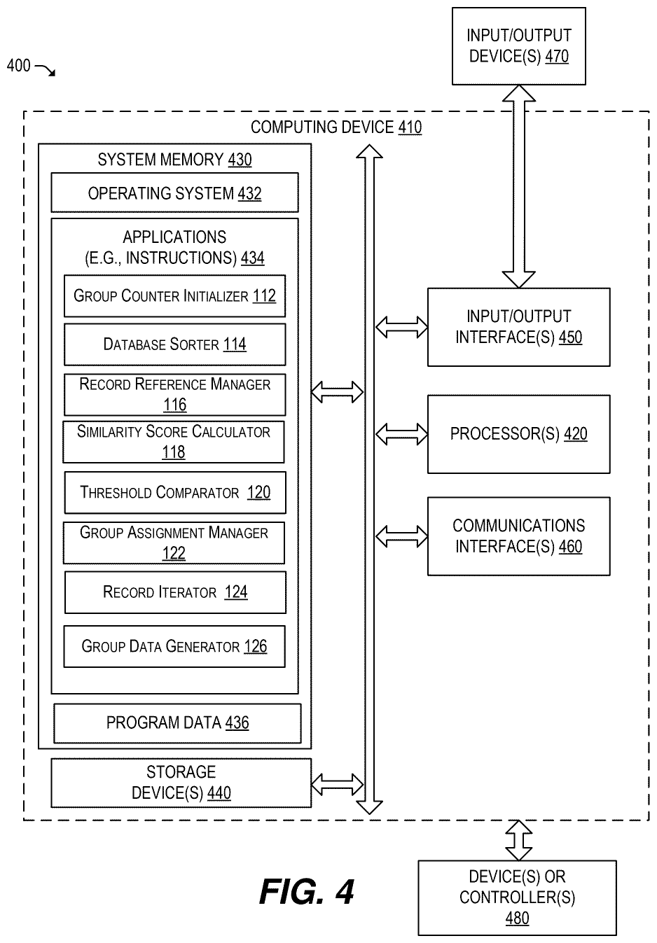

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 4 depicts a computing device 410 including one or more processors (“processor(s)” 420 in FIG. 4), which indicates that in some implementations the computing device 410 includes a single processor 420 and in other implementations the computing device 410 includes multiple processors 420. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

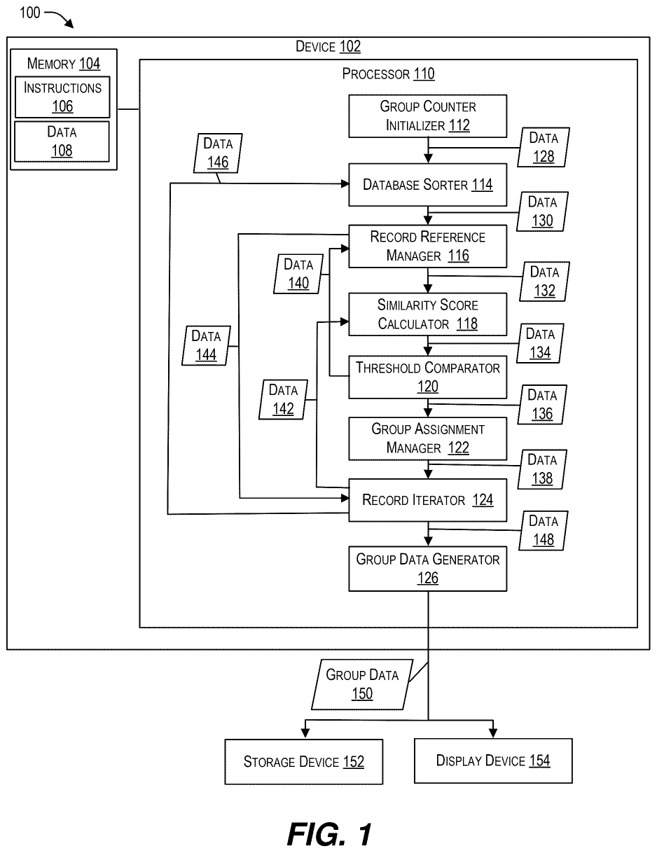

FIG. 1 is a diagram that illustrates a system 100 that includes a device 102. The device 102 is configured to generate group data 150 that includes one or more homogeneous reliability groups. The system 100 includes a memory 104 coupled to one or more processors 110. The memory 104 includes instructions 106 and data 108.

The processor(s) 110 includes a group counter initializer 112, a database sorter 114, a record reference manager 116, a similarity score calculator 118, a threshold comparator 120, a group assignment manager 122, a record iterator 124, and a group data generator 126. These components work together to implement a method for generating homogeneous reliability groups from calibration device data.

To illustrate the operation of these components and their associated data flows, consider the following example dataset, as illustrated below in Table 1, of four calibration devices stored as data 108 in memory 104:

TABLE 1

| | Noun/ | Make/ | | | | Shop |
|---|---|---|---|---|---|---|
| Device | Nomenclature | Model | Manufacturer | Procedure | Group | Code |
| 1 | Digital | TM2000 | TechCorp | CP-001 | RG-A | LAB-1 |
| | Multimeter | | | | | |
| 2 | Digital | TM2000 | TechCorps | CP-002 | RG-A | LAB-1 |
| | Voltmeter | | | | | |
| 3 | Analog | AM1000 | TechCorp | CP-001 | RG-B | LAB-2 |
| | Multimeter | | | | | |
| 4 | Digital | TM2000 | TechCorp | CP-001 | RG-B | LAB-1 |
| | Multimeter | | | | | |

The group counter initializer 112 obtains data including a plurality of records, where each record is associated with a particular calibrated device. The group counter initializer 112 handles initialization of group counters by setting a group counter to zero and generates data 128 (e.g., initialization data) indicative of the counter being set and the obtained data 108.

The database sorter 114 receives the data 128 and manages database sorting operations. The database sorter 114 is configured to first sort the plurality of records by a first field, such as the Noun/Nomenclature field comprising text data, and generates data 130 (e.g., sorted data). The database sorter 114 can also sort the plurality of records by a second field, such as a make/model number field comprising alphanumeric data.

In some implementations, the database sorter 114 is configured to sort the plurality of records by multiple fields in a specific order. For example, the database sorter 114 may first sort by the Noun/Nomenclature field, followed by sorting by other fields such as make/model number. The order of sorting corresponds to the weighting scheme, where fields sorted earlier in the process receive higher weights in the similarity calculations. For instance, when the Noun/Nomenclature field is sorted first, it receives a higher weight (e.g., 0.3) compared to fields sorted later (e.g., 0.2 for make/model number).

In some implementations, the database sorter 114 may implement a three-stage sorting process. For example, first, the database sorter 114 sorts by the Noun/Nomenclature field (first field), followed by the make/model number field (second field), and finally by the manufacturer field (third field). For each sort stage, the database sorter 114 processes each record in the sorted plurality of records by comparing the record's fields to those of other records in the sorted plurality. These comparisons include comparing the first field (e.g., Noun/Nomenclature) to determine a first similarity metric and comparing the second field (e.g., make/model number) to determine a second similarity metric. The threshold comparator 120 then determines an aggregate similarity metric based on these comparisons, and the group assignment manager 122 assigns the record to a calibration reliability group based on the aggregate similarity metric. The weighting scheme follows the sort order, with the first field receiving the highest weight (e.g., 0.3), the second field receiving a lower weight (e.g., 0.2), and the third field receiving an even lower weight (e.g., 0.15), ensuring that fields sorted earlier in the process have greater influence on the grouping decisions.

The record reference manager 116 receives the data 130 and handles record retrieval and reference point management. The record reference manager 116 is configured to retrieve and read a first record from the sorted database and to assign a first value of the group counter to this reference record's group ID value. The record reference manager 116 also manages the selection of subsequent records as reference records when the current record does not meet the similarity threshold with the existing reference record. The record reference manager 116 is configured to generate data 132 (e.g., reference data) indicative of the current reference record and the record to be compared.

The similarity score calculator 118 is configured to receive the data 132 and compare a first field of a first data record to a first field of a second data record to determine a first similarity metric based on a number of single character changes used to convert a value of the first field of the first data record to a value of the first field of the second data record. In general, the similarity score calculator 118 is configured to use the Levenshtein distance between two strings a, b (of length |a| and |b| respectively) is given by lev(a, b) where:

$$lev ( a , b ) = \{ \begin{matrix}\vert a \vert & if \vert b \vert = 0 \\ \vert b \vert & if \vert a \vert = 0 \\ lev ( tail ( a ) , tail ( b ) ) & if head ( a ) = head ( b ) \\ 1 + min \{ \begin{matrix}lev ( tail ( a ) , b ) \\ lev ( a , tail ( b ) ) \\ lev ( tail ( a ) , tail ( b ) )\end{matrix} & otherwise\end{matrix} ,$$

To illustrate the Levenshtein distance calculation, consider the comparison between Device 1 and Device 2's Noun/Nomenclature fields. The similarity score calculator 118 calculates:

$$Sim - score - noun ( R 1 , R 2 ) = 1 - ( lev ( {}^{‶} DIGITAL {MULTIMETER}^{″} , {}^{‶} DIGITAL {VOLTMETER}^{″} ) / max ( len ( ( {}^{‶} DIGITAL {MULTIMETER}^{″} ) , len ( {}^{‶} DIGITAL VOLTMETER ” ) ) ) = 1 - ( 3 / 18 ) = 0.833$$

Here, a Levenshtein distance of 3 represents the minimum number of single-character changes required to transform “MULTIMETER” to “VOLTMETER”, indicating a moderate level of text similarity between these fields.

For fields requiring exact matches, the similarity score calculator 118 employs a binary distance approach. This method compares a second field of the first data record to a second field of the second data record to determine a second similarity metric. The binary distance calculation is defined as:

$$Sim - score - field ( R 1 , R 2 ) = bin ( R 1 - field , R 2 - field )$$

Where bin(a,b)=1 if a and b are identical, and 0 if they differ in any way

To demonstrate this binary comparison approach, consider the Make/Model field comparison between Device 1 and Device 2:

$$Sim - score - model ( R 1 , R 2 ) = bin ( {}^{‶} TM {2000}^{″} , {}^{‶} TM {2000}^{″} ) = 1$$

In this example, the exact match between the Make/Model values results in a binary similarity score of 1, indicating perfect similarity for this field.

The similarity score calculator 118 compiles these Levenshtein and binary similarity metrics into data 134 (e.g., similarity data), which provides an assessment of field-by-field similarity between the compared devices. In some aspects, the similarity score calculator 118 can compare additional fields beyond the first and second fields. For text fields, such as the manufacturer field, the calculator uses the Levenshtein distance approach. For non-text fields, such as the procedure number or shop code, the calculator uses the binary distance approach. These additional field comparisons are incorporated into the aggregate similarity metric using the weighted sum approach.

The threshold comparator 120 is configured to receive the data 134 and determine an aggregate similarity metric based on weighted similarity metrics. Continuing the above example, the following weights are assigned to each field as illustrated in Table 2 below:

TABLE 2

| Field | Weight |
|---|---|
| Noun/Nomenclature | 0.3 |
| Make/Model | 0.2 |
| Manufacturer | 0.15 |
| Procedure | 0.15 |
| Group | 0.1 |
| Shop Code | 0.1 |

Calculating a similarity score for the comparison of Devices 1 and 2 is illustrated in Table 3 below:

TABLE 3

| Field | Score | Calculation | Explanation |
|---|---|---|---|
| Noun/ | 0.833 | 1-(3/18) | Levenshtein |
| Nomenclature | | | distance of 3, max |
| | | | length 18 |
| Make/Model | 1.000 | N/A | Exact Match |
| Manufacturer | 0.875 | N/A | Levenshtein |
| | | | distance of 1 |
| Procedure | 0.000 | 1-(1/8) | Not an exact match |
| Group | 1.000 | N/A | Exact Match |
| Shop Code | 1.000 | N/A | Exact Match |

The aggregate similarity score is calculated using a weighted sum of individual field scores:

$$Overall similarity score = [ 0.3 * 0.833 + 0.2 * 1 + 0.15 * 0.875 + 0.15 * 0 + 0.1 * 1 + 0.1 * 1 ] = 0.78115$$

This aggregate similarity score of 0.78115 indicates that Devices 1 and 2 have moderate similarity but fall below the threshold value of 0.8. As a result, Device 2 would be assigned to a different calibration reliability group than Device 1, as the differences in their attributes, particularly in the Noun/Nomenclature and Procedure fields, suggest they should be managed separately for calibration purposes.

In another example, calculating a similarity score for the comparison of Devices 1 and 4 is illustrated in Table 4 below:

TABLE 4

| Field | Score | Calculation | Explanation |
|---|---|---|---|
| Noun/ | 0.833 | 1-(3/18) | Levenshtein |
| Nomenclature | | | distance of 3, max |
| | | | length 18 |
| Make/Model | 1.000 | N/A | Exact Match |
| Manufacturer | 0.875 | N/A | Levenshtein |
| | | | distance of 1 |
| Procedure | 0.000 | 1-(1/8) | Not an exact match |
| Group | 1.000 | N/A | Exact Match |
| Shop Code | 1.000 | N/A | Exact Match |

$$Overall similarity score = [ 0.3 * 1 + 0.2 * 1 + 0.15 * 1 + 0.15 * 1 + 0.1 * 1 + 0.1 * 1 ] = 1.$$

A similarity score of 1.0 indicates that Devices 1 and 4 are identical across all compared fields. Since this score exceeds the threshold value of 0.8, Device 4 would be assigned to the same calibration reliability group as Device 1. This grouping ensures that devices with similar specifications and characteristics (e.g., having a similarity score that is greater than or equal to the threshold value) are managed under the same calibration regime, promoting consistency in their maintenance and reliability assessment.

The threshold comparator 120 is configured to generate data 136 (e.g., threshold data) by comparing each aggregate similarity metric to a predefined threshold (e.g., 0.8). This comparison determines the grouping outcome—as demonstrated in the examples above, Device 2 with its similarity score of 0.78115 would be assigned to a different calibration reliability group than Device 1, while Device 4 with its perfect similarity score of 1.0 would be assigned to the same group as Device 1.

The group assignment manager 122 is configured to receive the data 136 and to assign records to calibration reliability groups. When the aggregate similarity metric is greater than or equal to the threshold, the second data record is assigned to the calibration reliability group of the first data record. When the metric is below the threshold, the second data record is assigned to a different calibration reliability group. The group assignment manager 122 generates data 138 (e.g., assignment data) indicating the group assignments and updated counter values. In some implementations, the group assignment manager 122 includes error detection and handling capabilities. For example, when encountering data inconsistencies (e.g., mismatched field lengths, invalid characters), the group assignment manager 122 can apply data cleaning rules before group assignment. The group assignment manager 122 can also flag potential errors for human review when confidence scores for group assignments fall below a secondary threshold, allowing for manual verification of borderline cases.

In some implementations, the group assignment manager 122 can be configured to employ various clustering algorithms to assist in assigning records to calibration reliability groups based on the aggregate similarity metrics. These clustering algorithms can include k-means clustering, DBSCAN clustering, Gaussian Mixture Models clustering, or Hierarchical clustering. The selection of the specific clustering algorithm depends on the characteristics of the data and the desired grouping outcomes. For example, k-means clustering may be used when the number of desired groups is known in advance, while DBSCAN clustering may be preferred when dealing with datasets containing noise or outliers. The fields used for comparison typically include a noun/nomenclature field comprising text data that describes the type of device (e.g., “DIGITAL MULTIMETER”, “FEELER GAUGE”) and a make/model number field comprising alphanumeric data that uniquely identifies the specific model of the device (e.g., “TM2000”, “AM1000”).

In some implementations, the group assignment manager 122 can dynamically select between different clustering algorithms based on data characteristics. For example, when the dataset includes significant outliers, the group assignment manager 122 may automatically switch from k-means to DBSCAN clustering. The group assignment manager 122 can also combine multiple clustering algorithms in a hierarchical approach, using k-means clustering for initial grouping followed by hierarchical clustering for refinement. Additionally, the group assignment manager 122 can adjust clustering parameters (e.g., distance metrics, cluster size thresholds) based on the specific device types being analyzed.

In some implementations, the fields used for comparison can also include derived or calculated fields that combine multiple attributes. For example, a composite reliability score field may be calculated from historical calibration data, maintenance records, and age of the device. The group assignment manager 122 can apply different similarity metrics to these derived fields, such as range-based comparisons for numerical scores or fuzzy matching for composite text fields.

The record iterator 124 is configured to receive the data 138 and control iteration through records. The record iterator 124 is configured to check for additional records in the sorted database and for more sort categories. When additional sort categories exist, the record iterator 124 is configured to increment the group counter by N+1, where N represents the number of groups created in the previous sort category.

The threshold comparator 120 is configured to generate data 140 (e.g., threshold data) containing threshold comparison results. For example, when comparing Devices 1 and 2, the data 140 would indicate that their aggregate similarity score of 0.78115 falls below the 0.8 threshold, signaling the use of different group assignments. This data 140 is transmitted to the record reference manager 116 to guide further processing decisions.

The record iterator 124 is configured to generate data 142 (e.g., iteration data) indicating which records to process next. For instance, after comparing Devices 1 and 2, data 142 would direct the similarity score calculator 118 to compare Device 1 with Device 3, followed by Device 4.

The record reference manager 116 is configured to generate reference data 144 containing the current reference records and their comparisons. For example, as illustrated in table 5 below:

TABLE 5

| | | | | | | |
|---|---|---|---|---|---|---|
| | Noun/ | Make/ | | | | Shop |
| Device | Nomenclature | Model | Manufacturer | Procedure | Group | Code |

Reference Device:

| | | | | | | |
|---|---|---|---|---|---|---|
| 1 | Digital | TM2000 | TechCorp | CP-001 | RG-A | Lab-1 |
| | Multimeter | | | | | |

Comparison Queue:

| | | | | | | |
|---|---|---|---|---|---|---|
| 3 | Analog | AM1000 | TechCorp | CP-001 | RG-B | LAB-2 |
| | Multimeter | | | | | |
| 4 | Digital | TM2000 | TechCorp | CP-001 | RG-A | LAB-1 |
| | Multimeter | | | | | |

The record iterator 124 is configured to receive the data 144 and generate data 146 that is indicative of the sorting status. For example, after completing Noun/Nomenclature field comparisons, the data 146 would trigger the database sorter 114 to perform secondary sorting by Make/Model number. The record iterator 124 is also configured to generate data 148 that is indicative of the tracking completion status. For example, the data 148 can indicate that three comparisons have been completed (e.g., 1-2, 1-3, 1-4) with no remaining records to process.

The group data generator 126 is configured to receive the data 148, and generate group data 150. For example, the final grouping is illustrated in Table 6 below:

TABLE 6

| Group | Devices | Reason |
|---|---|---|
| 1 | Device 1, | Identical attributes |
| | Device 4 | (similarity score 1.0) |
| 2 | Device 2 | Different |
| | | Noun/Nomenclature and |
| | | Procedure (similarity |
| | | score 0.78115) |
| 3 | Device 3 | Different |
| | | Noun/Nomenclature and |
| | | Make/Model (similarity |
| | | score 0.47917) |

The group data 150 is transmitted to a display device 154 configured to display the group data 150 and receive user input confirming the group data is correct. The group data 150 is also transmitted to a storage device 152 configured to store the group data 150, where the storage device 152 can be separated from the device 102.

In alternative implementations, the system 100 can operate in a distributed computing environment where different components are implemented on separate computing devices. For example, the similarity score calculator 118 could be implemented on a dedicated high-performance computing node while the group assignment manager 122 operates on a separate node optimized for database operations. This distributed architecture enables parallel processing of large device inventories while maintaining system responsiveness.

By using the techniques and systems described herein, the device 102 has the technical advantages of providing automated, accurate, and consistent grouping of devices through a similarity-based clustering approach. The system's implementation of both Levenshtein distance for text-based comparisons and binary distance for exact-match fields offers significant improvements over existing manual grouping methods by eliminating human subjectivity and reducing the risk of non-homogeneous grouping errors that can lead to incorrect calibration intervals.

Furthermore, the device 102 provides enhanced operational efficiency through its weighted multi-attribute comparison system. The device's 102 ability to process multiple data fields with customized weightings, combined with its threshold-based decision making, ensures that devices are grouped with appropriate similar devices while maintaining distinct groups for devices with meaningful differences. This systematic approach eliminates the labor-intensive manual review process and reduces the risk of inappropriate groupings that could compromise measurement accuracy and reliability.

The device 102 also offers the technical advantage of scalable and dynamic group management through its iterative processing capabilities. By implementing a sorting and comparison methodology that can handle large datasets efficiently, the system enables organizations to maintain consistent grouping practices across their entire inventory of devices. The ability to automatically adjust groupings based on configurable similarity thresholds further streamlines the management of calibration reliability groups while ensuring that the grouping criteria remain appropriate for different types of devices.

The device 102 further provides technical advantages through its adaptive field processing capabilities. By supporting both direct field comparisons and derived field calculations, the system can capture complex relationships between device characteristics that might not be apparent from individual attributes alone. This capability, combined with the dynamic clustering algorithm selection, enables the system to maintain grouping accuracy even as device inventories evolve and new device types are introduced.

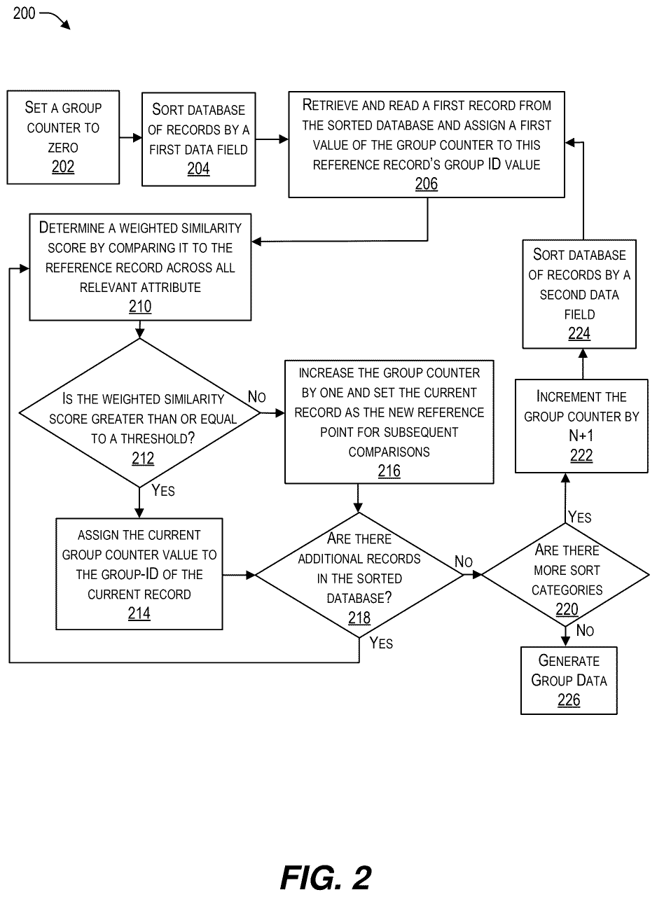

FIG. 2 is a flow diagram 200 illustrating operations performed by the device 102 to generate homogeneous reliability groups from the data 108. The device 102 is configured to execute the operations through the various components described in FIG. 1, including the group counter initializer 112, the database sorter 114, the record reference manager 116, the similarity score calculator 118, the threshold comparator 120, the group assignment manager 122, the record iterator 124, and the group data generator 126.

At block 202, the group counter initializer 112 sets a group counter to zero. This counter is used to assign unique identifiers to each reliability group created during the grouping process.

At block 204, the database sorter 114 sorts a database of records by a first data field. For example, the database can be sorted alphabetically by the Noun/Nomenclature field of Device 1 (e.g., “DIGITAL MULTIMETER”), Device 2 (e.g., “DIGITAL VOLTMETER”), and Device 3 (e.g., “DIGITAL OSCILLOSCOPE”), which comprises text data. This initial sorting helps bring potentially similar devices closer together in the database, potentially reducing the number of required comparisons and computing resources.

At block 206, the record reference manager 116 retrieves and reads a first record from the sorted database and assigns a first value of the group counter to this reference record's group ID value. For example, if the first record is for a “DIGITAL MULTIMETER” and the group counter is at 0, this record would be assigned a group ID of 0.

At block 210, the similarity score calculator 118 determines a weighted similarity score for each subsequent record by comparing it to the reference record across all relevant attributes. This comparison includes comparing a first field of Device 1 (e.g., a reference record) to a first field of Device 2 (e.g., a subsequent record) to determine a first similarity metric based on a number of single character changes used to convert a value of the first field of Device 1 to a value of the first field of Device 2. The similarity score calculator 118 also compares a second field of Device 1 to a second field of Device 2 to determine a second similarity metric based on whether the second field of Device 1 is identical to a value of the second field of Device 2. The threshold comparator 120 then determines an aggregate similarity metric based on at least the first similarity metric and the second similarity metric.

At block 212, the threshold comparator 120 determines whether the weighted similarity score is greater than or equal to a threshold. When the weighted similarity score is greater than or equal to the threshold, at block 214, the group assignment manager 122 assigns the current group counter value to the group ID of the current record. For example, if the similarity score between Device 2 (e.g., a “DIGITAL VOLTMETER”) and Device 1 (e.g., the reference “DIGITAL MULTIMETER”) exceeds the threshold of 0.8, the Device 2 (e.g., “DIGITAL VOLTMETER”) would be assigned to the same group as Device 1 (e.g., the reference record).

When the similarity score is below the threshold, at block 216, the group assignment manager 122 increments the group counter by one and the record reference manager 116 sets the current record as the new reference point for subsequent comparisons. For instance, if Device 3 (e.g., a “DIGITAL OSCILLOSCOPE” record) has insufficient similarity to the current reference record, it becomes a new reference point with a new group ID.

At block 218, after either assigning a group ID or establishing a new reference point, the record iterator 124 determines whether there are additional records in the sorted database to process. When there are more records, the flow diagram returns to block 210 to process the next record.

When there are no more records to process, at block 220, the record iterator 124 determines whether there are more sort categories to process. When there are more categories, at block 222, the group counter initializer 112 increments the group counter by N+1, where N is the number of groups created in the previous sort. For example, if 5 groups were created in the Noun/Nomenclature sort, the group counter would be incremented by 6 (5+1) for the next sort category.

At block 224, the database sorter 114 sorts the database by a second data field, such as the make/model number field comprising alphanumeric data. The flow diagram then returns to block 208 to begin grouping records based on this new sorting criterion. The process continues until all records have been evaluated under each sorting criterion.

When all sort categories have been processed, at block 226, the group data generator 126 generates group data comprising the homogeneous reliability groups. This group data can then be stored in the memory 104, transmitted to the storage device 152 or display device 154 for further processing, used to perform other data processing operations, or a combination thereof.

Through the execution of these operations by the components of device 102, devices can be automatically grouped based on their similarities across multiple attributes, ensuring consistent and accurate reliability groupings while reducing manual effort and potential errors in the grouping process.

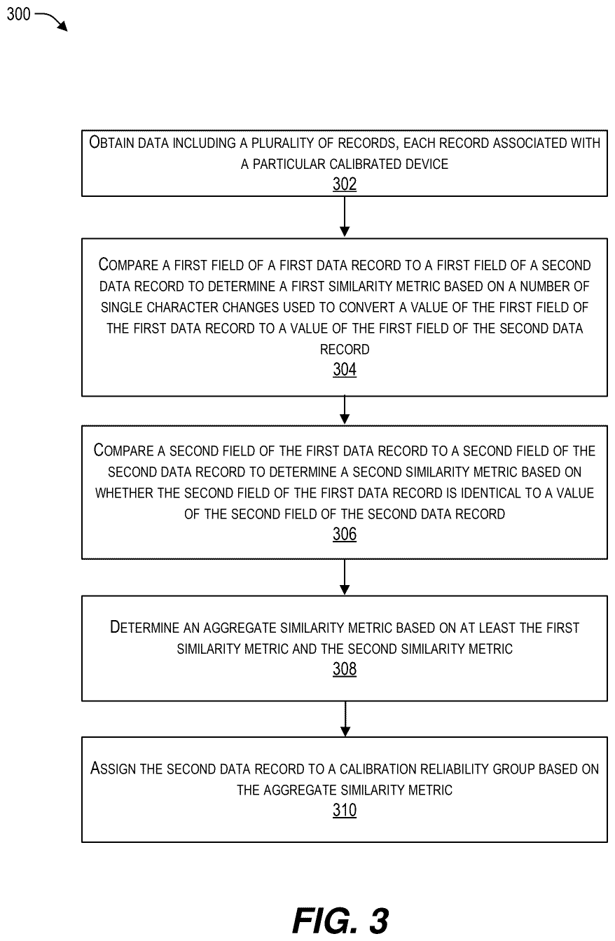

FIG. 3 illustrates a method 300 of generating homogenous reliability groups. The method 300 includes, at block 302, obtaining data 108 including a plurality of records, each record associated with a particular calibrated device. For example, the group counter initializer 112 obtains from memory 104 the data 108 that includes records for Device 1 (e.g., a “DIGITAL MULTIMETER” with make/model “TM2000” from manufacturer “TechCorp”), Device 2 (e.g., a “DIGITAL VOLTMETER” with make/model “TM2000” from manufacturer “TechCorps”), and Device 3 (e.g., an “ANALOG MULTIMETER” with make/model “AM1000” from manufacturer “TechCorp”).

The method 300 includes, at block 304, comparing a first field of a first data record to a first field of a second data record to determine a first similarity metric based on a number of single character changes used to convert a value of the first field of the first data record to a value of the first field of the second data record. For example, the similarity score calculator 118 compares the Noun/Nomenclature field of Device 1 (e.g., “DIGITAL MULTIMETER”) to Device 2 (e.g., “DIGITAL VOLTMETER”) by performing a Levenshtein distance calculation that determines four single character changes are required to transform “MULTIMETER” to “VOLTMETER”, resulting in a similarity metric of 0.833 (calculated as 1−( 3/18), where 18 is the maximum length).

The method 300 includes, at block 306, comparing a second field of the first data record to a second field of the second data record to determine a second similarity metric based on whether the second field of the first data record is identical to a value of the second field of the second data record. For example, the similarity score calculator 118 compares the Make/Model field of Device 1 (e.g., “TM2000”) to Device 2 (e.g., “TM2000”) using a binary distance calculation. The similarity score calculator 118 determines that the values are identical, resulting in a similarity metric of 1.0. When the similarity score calculator 118 compares Device 1 to Device 3 (e.g., “AM1000”), it generates a similarity metric of 0 since the values are not identical.

The method 300 includes, at block 308, determining an aggregate similarity metric based on at least the first similarity metric and the second similarity metric. For example, the threshold comparator 120 applies a weighted sum approach where the Noun/Nomenclature field has a weight of 0.3 and the Make/Model field has a weight of 0.2. The threshold comparator 120 calculates the aggregate similarity metric for Device 1 and Device 2 as [0.3*0.833+0.2*1.0+(weights and metrics for additional fields)]=0.78115.

The method 300 includes, at block 310, assigning the second data record to a calibration reliability group based on the aggregate similarity metric. For example, the group assignment manager 122 compares the aggregate similarity metric of 0.78115 between Device 1 and Device 2 to a threshold value of 0.8. Since the metric is below the threshold, the group assignment manager 122 assigns Device 2 to a different calibration reliability group than Device 1. When the group assignment manager 122 processes Device 4 (e.g., another “DIGITAL MULTIMETER” with identical attributes to Device 1) having a similarity metric of 1.0, it assigns Device 4 to the same calibration reliability group as Device 1, and the group data generator 126 stores these group assignments in the group data 150.

FIG. 4 is a block diagram of a computing environment 400 including a computing device 410 configured to support aspects of computer-implemented methods and computer-executable program instructions (or code) according to the present disclosure. For example, the computing device 410, or portions thereof, is configured to execute instructions to initiate, perform, or control one or more operations described with reference to FIGS. 1-3.

The computing device 410 includes one or more processors 420. In some aspects, the processor(s) 420 includes the processor(s) 110, as described in FIG. 1. The processor(s) 420 are configured to communicate with system memory 430, one or more storage devices 440, one or more input/output interfaces 450, one or more communications interfaces 460, or any combination thereof. The system memory 430 includes volatile memory devices (e.g., random access memory (RAM) devices), nonvolatile memory devices (e.g., read-only memory (ROM) devices, programmable read-only memory, and flash memory), or both. The system memory 430 stores an operating system 432, which may include a basic input/output system for booting the computing device 410 as well as a full operating system to enable the computing device 410 to interact with users, other programs, and other devices. The system memory 430 stores system (program) data 436, such as the group counter initializer 112, the database sorter 114, the record reference manager 116, the similarity score calculator 118, the threshold comparator 120, the group assignment manager 122, the record iterator 124, the group data generator 126, or a combination thereof.

The system memory 430 includes one or more operating systems 432 and/or one or more applications 434 (e.g., sets of instructions) executable by the processor(s) 420. As an example, the one or more applications 434 include instructions executable by the processor(s) 420 to initiate, control, or perform one or more operations described with reference to FIGS. 1-3, such as obtaining data including a plurality of records, each record associated with a particular calibrated device, comparing a first field of a first data record to a first field of a second data record to determine a first similarity metric based on a number of single character changes used to convert a value of the first field of the first data record to a value of the first field of the second data record, comparing a second field of the first data record to a second field of the second data record to determine a second similarity metric based on whether the second field of the first data record is identical to a value of the second field of the second data record, determining an aggregate similarity metric based on at least the first similarity metric and the second similarity metric, and assigning the second data record to a calibration reliability group based on the aggregate similarity metric.

In a particular implementation, the system memory 430 includes a non-transitory, computer-readable medium storing the instructions that, when executed by the processor(s) 420, cause the processor(s) 420 to initiate, perform, or control operations to aid in generating homogenous reliability groupings. The operations include obtaining data including a plurality of records, each record associated with a particular calibrated device, comparing a first field of a first data record to a first field of a second data record to determine a first similarity metric based on a number of single character changes used to convert a value of the first field of the first data record to a value of the first field of the second data record, comparing a second field of the first data record to a second field of the second data record to determine a second similarity metric based on whether the second field of the first data record is identical to a value of the second field of the second data record, determining an aggregate similarity metric based on at least the first similarity metric and the second similarity metric, and assigning the second data record to a calibration reliability group based on the aggregate similarity metric.

The one or more storage devices 440 include nonvolatile storage devices, such as magnetic disks, optical disks, or flash memory devices. In a particular example, the storage devices 440 include both removable and non-removable memory devices. The storage devices 440 are configured to store an operating system, images of operating systems, applications (e.g., one or more of the applications 434), and program data (e.g., the program data 436). In a particular aspect, the system memory 430, the storage devices 440, or both, include tangible computer-readable media. In a particular aspect, one or more of the storage devices 440 are external to the computing device 410.

The one or more input/output interfaces 450 enable the computing device 410 to communicate with one or more input/output devices 470 to facilitate user interaction. For example, the one or more input/output interfaces 450, an input interface, or both. For example, the input/output interface 450 is adapted to receive input from a user, to receive input from another computing device, or a combination thereof. In some implementations, the input/output interface 450 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 470 includes one or more user interface devices and displays, including some combination of buttons, keyboards, pointing devices, displays, speakers, microphones, touch screens, and other devices.

The processor(s) 420 are configured to communicate with devices or controllers 480 via the one or more communications interfaces 460. For example, the one or more communications interfaces 460 can include a network interface.

In some implementations, a non-transitory, computer-readable medium stores instructions that, when executed by one or more processors, cause the one or more processors to initiate, perform, or control operations to perform part or all of the functionality described above. For example, the instructions may be executable to implement one or more of the operations or methods of FIGS. 1-3. In some implementations, part, or all of one or more of the operations or methods of FIGS. 1-3 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:

According to Example 1, a method includes obtaining data including a plurality of records, each record associated with a particular calibrated device; comparing a first field of a first data record to a first field of a second data record to determine a first similarity metric based on a number of single character changes used to convert a value of the first field of the first data record to a value of the first field of the second data record; comparing a second field of the first data record to a second field of the second data record to determine a second similarity metric based on whether the second field of the first data record is identical to a value of the second field of the second data record; determining an aggregate similarity metric based on at least the first similarity metric and the second similarity metric; and assigning the second data record to a calibration reliability group based on the aggregate similarity metric.

Example 2 includes the method of Example 1, wherein the first field is a text field, and the method further comprises comparing a third field of the first data record to a third field of the second data record, wherein the third field is a text field, to determine a third similarity metric based on a number of single character changes used to convert a value of the third field of the first data record to a value of the third field of the second data record; and wherein the aggregate similarity metric is further based on the third similarity metric.

Example 3 includes the method of Example 1 or Example 2, wherein the method further comprises: comparing a third field of the first data record to a third field of the second data record, wherein the third field is a non-text field, to determine a third similarity metric based on whether the third field of the first data record is identical to a value of the third field of the second data record; and wherein the aggregate similarity metric is further based on the third similarity metric.

Example 4 includes the method of any of Examples 1 to 3, wherein determining the aggregate similarity metric further comprises applying a weight to at least one of the first similarity metric, the second similarity metric, or both.

Example 5 includes the method of any of Examples 1 to 4 and further includes sorting the plurality of records prior to comparing the first field of the first data record to the first field of the second data record.

Example 6 includes the method of any of Examples 1 to 5, wherein assigning the second data record to the calibration reliability group based on the aggregate similarity metric further comprises: comparing the aggregate similarity metric to a threshold; and based on the aggregate similarity metric being greater than or equal to the threshold, assigning the second data record to the calibration reliability group of the first data record when the aggregate similarity metric satisfies the threshold.

Example 7 includes the method of any of Examples 1 to 6, wherein assigning the second data record to the calibration reliability group based on the aggregate similarity metric further comprises: comparing the aggregate similarity metric to a threshold; and based on the aggregate similarity metric being less than the threshold, assigning the second data record to a different calibration reliability group than the calibration reliability group of the first data record.

Example 8 includes the method of any of Examples 1 to 7, further includes sorting the plurality of records by a third field; for each record in the sorted plurality of records: comparing a first field of the record to a first field of at least one other record in the sorted plurality to determine a first similarity metric; comparing a second field of the record to a second field of the at least one other record in the sorted plurality to determine a second similarity metric; determining an aggregate similarity metric based on at least the first similarity metric and the second similarity metric; and assigning the record to a calibration reliability group based on the aggregate similarity metric.

Example 9 includes the method of Example 8, wherein sorting the plurality of records by the first field occurs prior to sorting the plurality of records by the third field, and wherein a weight associated with the first field is greater than a weight associated with the third field.

Example 10 includes the method of any of Examples 1 to 9, wherein assigning the second data record to the calibration reliability group based on the aggregate similarity metric further comprises performing a clustering algorithm on the plurality of records.

Example 11 includes the method of Example 10, wherein the clustering algorithm is selected from one or more of: k-means clustering, DBSCAN clustering, Gaussian Mixture Models clustering, or Hierarchical clustering.

Example 12 includes the method of any of Examples 1 to 11, wherein the first field is a noun/nomenclature field comprising text data.

Example 13 includes the method of any of Examples 1 to 12, wherein the second field is a make/model number field comprising alphanumeric data.

According to Example 14, a non-transitory computer-readable medium storing instructions that, when executed by one or more processors, cause the one or more processors to obtain data including a plurality of records, each record associated with a particular calibrated device; compare a first field of a first data record to a first field of a second data record to determine a first similarity metric based on a number of single character changes used to convert a value of the first field of the first data record to a value of the first field of the second data record; compare a second field of the first data record to a second field of the second data record to determine a second similarity metric based on whether the second field of the first data record is identical to a value of the second field of the second data record; determine an aggregate similarity metric based on at least the first similarity metric and the second similarity metric; and assign the second data record to a calibration reliability group based on the aggregate similarity metric.

Example 15 includes the non-transient computer-readable medium of Example 14, wherein the first field is a text field, and wherein the one or more processors are configured to compare a third field of the first data record to a third field of the second data record, wherein the third field is a text field, to determine a third similarity metric based on a number of single character changes used to convert a value of the third field of the first data record to a value of the third field of the second data record; and wherein the aggregate similarity metric is further based on the third similarity metric.

Example 16 includes the non-transient computer-readable medium of Example 14 or Example 15, wherein the one or more processors are configured to compare a third field of the first data record to a third field of the second data record, wherein the third field is a non-text field, to determine a third similarity metric based on whether the third field of the first data record is identical to a value of the third field of the second data record; and wherein the aggregate similarity metric is further based on the third similarity metric.

Example 17 includes the non-transient computer-readable medium of any of Examples 14 to 16, wherein the one or more processors are configured to apply a weight to at least one of the first similarity metric, the second similarity metric, or both.

Example 18 includes the non-transient computer-readable medium of any of Examples 14 to 17, wherein the one or more processors are configured to sort the plurality of records prior to comparing the first field of the first data record to the first field of the second data record.

Example 19 includes the non-transient computer-readable medium of any of Examples 14 to 18, wherein the one or more processors are configured to comparing the aggregate similarity metric to a threshold; and based on the aggregate similarity metric being greater than or equal to the threshold, assigning the second data record to the calibration reliability group of the first data record when the aggregate similarity metric satisfies the threshold.

According to Example 20, a device includes one or more processors coupled to a memory configured to obtain data including a plurality of records, each record associated with a particular calibrated device; compare a first field of a first data record to a first field of a second data record to determine a first similarity metric based on a number of single character changes used to convert a value of the first field of the first data record to a value of the first field of the second data record; compare a second field of the first data record to a second field of the second data record to determine a second similarity metric based on whether the second field of the first data record is identical to a value of the second field of the second data record; determine an aggregate similarity metric based on at least the first similarity metric and the second similarity metric; and assign the second data record to a calibration reliability group based on the aggregate similarity metric.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

1. A method comprising:
obtaining data including a plurality of records, each record associated with a particular calibrated device;
comparing a first field of a first data record to a first field of a second data record to determine a first similarity metric based on a number of single character changes used to convert a value of the first field of the first data record to a value of the first field of the second data record;
comparing a second field of the first data record to a second field of the second data record to determine a second similarity metric based on whether the second field of the first data record is identical to a value of the second field of the second data record;
determining an aggregate similarity metric based on at least the first similarity metric and the second similarity metric; and
assigning the second data record to a calibration reliability group based on the aggregate similarity metric.

2. The method of claim 1, wherein the first field is a text field, and the method further comprises:
comparing a third field of the first data record to a third field of the second data record, wherein the third field is a text field, to determine a third similarity metric based on a number of single character changes used to convert a value of the third field of the first data record to a value of the third field of the second data record; and
wherein the aggregate similarity metric is further based on the third similarity metric.

3. The method of claim 1, wherein the method further comprises:
comparing a third field of the first data record to a third field of the second data record, wherein the third field is a non-text field, to determine a third similarity metric based on whether the third field of the first data record is identical to a value of the third field of the second data record; and
wherein the aggregate similarity metric is further based on the third similarity metric.

4. The method of claim 1, wherein determining the aggregate similarity metric further comprises applying a weight to at least one of the first similarity metric, the second similarity metric, or both.

5. The method of claim 1, further comprising sorting the plurality of records prior to comparing the first field of the first data record to the first field of the second data record.

6. The method of claim 1, wherein assigning the second data record to the calibration reliability group based on the aggregate similarity metric further comprises:
comparing the aggregate similarity metric to a threshold; and
based on the aggregate similarity metric being greater than or equal to the threshold, assigning the second data record to the calibration reliability group of the first data record when the aggregate similarity metric satisfies the threshold.

7. The method of claim 1, wherein assigning the second data record to the calibration reliability group based on the aggregate similarity metric further comprises:
comparing the aggregate similarity metric to a threshold; and
based on the aggregate similarity metric being less than the threshold, assigning the second data record to a different calibration reliability group than the calibration reliability group of the first data record.

8. The method of claim 1, further comprising:
sorting the plurality of records by a third field to produce a sorted plurality of records;
for each record in the sorted plurality of records:
comparing a first field of the record to a first field of at least one other record in the sorted plurality to determine a first similarity metric;
comparing a second field of the record to a second field of the at least one other record in the sorted plurality to determine a second similarity metric;
determining an aggregate similarity metric based on at least the first similarity metric and the second similarity metric; and
assigning the record to a calibration reliability group based on the aggregate similarity metric.

9. The method of claim 8, wherein sorting the plurality of records by the first field occurs prior to sorting the plurality of records by the third field, and wherein a weight associated with the first field is greater than a weight associated with the third field.

10. The method of claim 1, wherein assigning the second data record to the calibration reliability group based on the aggregate similarity metric further comprises performing a clustering algorithm on the plurality of records.

11. The method of claim 10, wherein the clustering algorithm is selected from one or more of: k-means clustering, DBSCAN clustering, Gaussian Mixture Models clustering, or Hierarchical clustering.

12. The method of claim 1, wherein the first field is a noun/nomenclature field comprising text data.

13. The method of claim 1, wherein the second field is a make/model number field comprising alphanumeric data.

14. A non-transitory computer-readable medium storing instructions that, when executed by one or more processors, cause the one or more processors to:
obtain data including a plurality of records, each record associated with a particular calibrated device;
compare a first field of a first data record to a first field of a second data record to determine a first similarity metric based on a number of single character changes used to convert a value of the first field of the first data record to a value of the first field of the second data record;
compare a second field of the first data record to a second field of the second data record to determine a second similarity metric based on whether the second field of the first data record is identical to a value of the second field of the second data record;
determine an aggregate similarity metric based on at least the first similarity metric and the second similarity metric; and
assign the second data record to a calibration reliability group based on the aggregate similarity metric.

15. The non-transient computer-readable medium of claim 14, wherein the first field is a text field, and wherein the one or more processors are configured to:
compare a third field of the first data record to a third field of the second data record, wherein the third field is a text field, to determine a third similarity metric based on a number of single character changes used to convert a value of the third field of the first data record to a value of the third field of the second data record; and
wherein the aggregate similarity metric is further based on the third similarity metric.

16. The non-transient computer-readable medium of claim 14, wherein the one or more processors are configured to:
compare a third field of the first data record to a third field of the second data record, wherein the third field is a non-text field, to determine a third similarity metric based on whether the third field of the first data record is identical to a value of the third field of the second data record; and
wherein the aggregate similarity metric is further based on the third similarity metric.

17. The non-transient computer-readable medium of claim 14, wherein the one or more processors are configured to apply a weight to at least one of the first similarity metric, the second similarity metric, or both.

18. The non-transient computer-readable medium of claim 14, wherein the one or more processors are configured to sort the plurality of records prior to comparing the first field of the first data record to the first field of the second data record.

19. The non-transient computer-readable medium of claim 14, wherein the one or more processors are configured to:
compare the aggregate similarity metric to a threshold; and
based on the aggregate similarity metric being greater than or equal to the threshold, assign the second data record to the calibration reliability group of the first data record when the aggregate similarity metric satisfies the threshold.

20. A device comprising:
one or more processors coupled to a memory configured to:
obtain data including a plurality of records, each record associated with a particular calibrated device;
compare a first field of a first data record to a first field of a second data record to determine a first similarity metric based on a number of single character changes used to convert a value of the first field of the first data record to a value of the first field of the second data record;
compare a second field of the first data record to a second field of the second data record to determine a second similarity metric based on whether the second field of the first data record is identical to a value of the second field of the second data record;
determine an aggregate similarity metric based on at least the first similarity metric and the second similarity metric; and
assign the second data record to a calibration reliability group based on the aggregate similarity metric.
